(19) United States
(12) Patent Application Publication
(10) Pub. No.: US 2004/0064953 A1
(43) Pub. Date: Apr. 8, 2004

(54) Single blade foldable knife

(75) Inventor: Yang-Fu Cheng, Taipei (TW)

Correspondence Address: BACON & THOMAS, PLLC, 4th Floor, 625 Slaters Lane, Alexandria, VA, 22314-1176, US

(73) Assignee: Kantas Products Co., Ltd., Taipei (TW)

(21) Appl. No.: 10/265,668

(22) Filed: Oct. 8, 2002

(51) Int. Cl. B26B 1/04

(52) U.S. Cl. 30/161; 30/155

(57) ABSTRACT

The invention is to provide a single blade foldable knife consisting of a planar-shaped handle section, a blade pivotably conjoined to an appropriate position at one extremity of the said handle section, and a protective component disposed on the said handle section at a position facing the tip of the blade cutting edge, such that when the blade is folded, the tip of the blade cutting edge is nested in the protective component, rendering the said cutting edge totally incapable of external contact and, therefore, the said protective component safeguards the user from injury due to touching the blade when the foldable knife is grasped, picked up, or carried, prevents the scoring of other objects by the cutting edge, and protects the cutting edge from wear due to other objects.

### BACKGROUND OF THE INVENTION

1) Field of the Invention

The invention herein relates to a single blade foldable knife.

2) Description of the Prior Art

A conventional single blade foldable knife consists of a planar-shaped handle section, a blade pivotably conjoined to an appropriate position at one extremity of the said handle section, a mildly contoured facet along the back of the said blade as well as a cutting edge formed on its opposite surface, and a resilient member suitably situated on the said handle section, the said resilient member providing for manual pressing by the user to fold the blade and, when the blade is unfolded, a section of the resilient member that is postured against the bottom portion of the blade to further lock the blade into position.

However, when the said conventional single blade foldable knife is folded, the tip of the blade cutting edge is exposed such that if the said foldable knife is incautiously grasped, picked up, or carried, the user is easily incised by the tip of the cutting edge and, furthermore, other objects stored with the said foldable knife are scored by the cutting edge, while the said cutting edge is worn down due to contact with other objects.

### SUMMARY OF THE INVENTION

The objective of the invention herein is to provide a single blade foldable knife consisting of a planar-shaped handle section, a blade pivotably conjoined to an appropriate position at one extremity of the said handle section, and a protective component disposed on the said handle section at a position facing the tip of the blade cutting edge, such that when the blade is folded, the tip of the blade cutting edge is nested in the protective component, rendering the said cutting edge totally incapable of external contact and, therefore, the said protective component safeguards the user from injury due to touching the blade when the foldable knife is grasped, picked up, or carried, prevents the scoring of other objects by the cutting edge, and protects the cutting edge from wear due to other objects.

The above and other objects, features and advantages of the present invention will become apparent from the following detailed description taken with the accompanying drawings.

### BRIEF DESCRIPTION OF THE DRAWINGS

FIG. 1 is an isometric drawing of the invention herein when unfolded.

FIG. 2 is an isometric drawing of the invention herein when folded.

FIG. 3 is an isometric drawing of another embodiment of the invention herein.

### DETAILED DESCRIPTION OF THE INVENTION

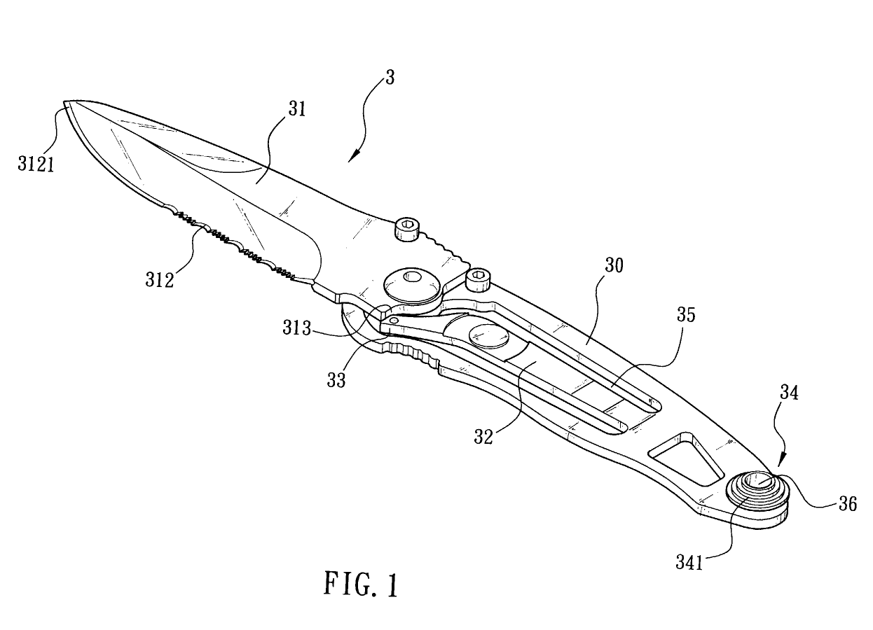

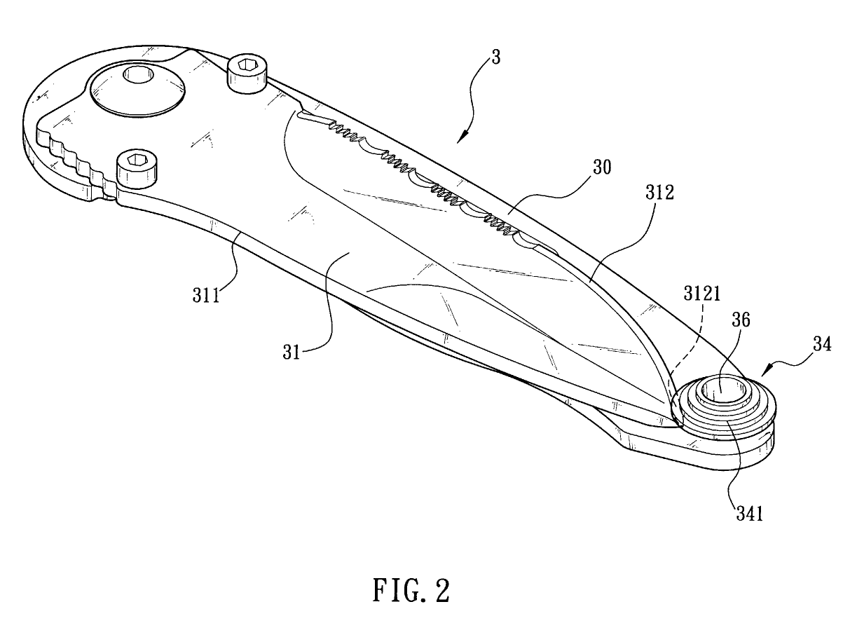

The invention herein is a single blade foldable knife; referring to FIG. 1 and FIG. 2, the embodiment of the invention herein consists of a foldable knife 3, a planar-shaped handle section 30 on which the said foldable knife 3 is disposed, a blade 31 pivotably conjoined to an appropriate position at one extremity of the said handle section 30, a mildly contoured facet 311 along the back of the said blade 31, a cutting edge 312 formed on the opposite surface, a channel 35 suitably inset proximal to the center of the said handle section 30, a resilient member 32 in the middle of the said channel 35, one end of the said resilient member 32 figured upward and, furthermore, slightly arcuate such that it has elastic properties, and a stop section 33 formed at the end of the said resilient member 32, with the said stop section 33 capable of being postured against a notch 313 in the bottom portion of the unfolded blade 31, thereby enabling the said stop section 33 to lock the said blade 31 into position after it is unfolded.

Referring to FIG. 1 and FIG. 2, a hole 36 is formed in the said handle section 30 at a position facing the blade 31 cutting edge 312 tip 3121 when the blade 31 is folded, a protective component 34 is situated on the said hole 36, a hollow rod fixes the said protective component 34 over the hole 36, and a protective circular cap 341 is mounted on the end of the said hollow rod such that a gap is formed between the said circular cap 341 and the handle section 30 that contains the cutting edge 312 tip 3121.

Given the said structural component assembly, when the blade 31 is folded, the tip 3121 of the blade 31 cutting edge 312 is nested in the protective component 34, enabling the said protective component 34 to ensconce the tip 3121 of the blade 31 cutting edge 312 and render the said cutting edge 312 totally incapable of external contact such that whether the user grasps, picks up, or carries the said foldable knife 3, touching the cutting edge 312 is not possible due to the containment of the said protective component 34 and, furthermore, other objects stored with the said foldable knife 3 cannot strike the said cutting edge 312, while wear of said cutting edge 312 is also prevented because it is isolated from other objects; therefore, the said protective component 34 achieves the objective of simultaneously protecting the user's hands and the cutting edge 312.

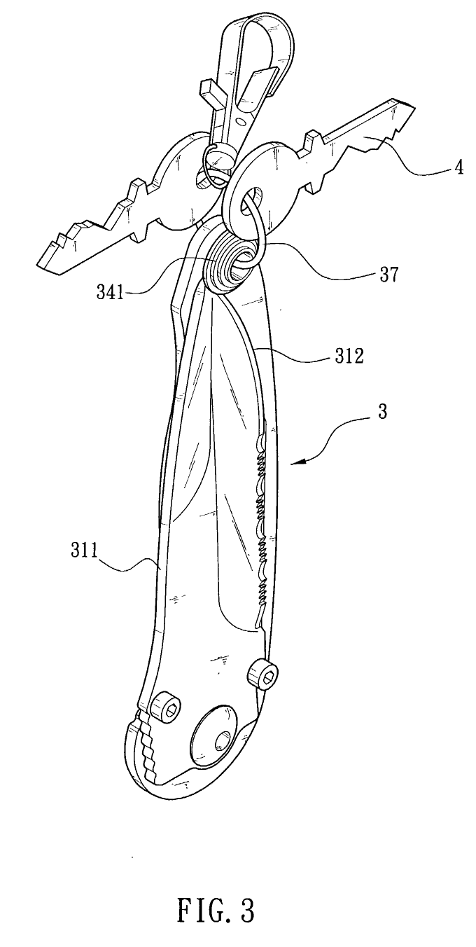

In the other embodiment of the invention herein, referring to FIG. 2 and FIG. 3, a chain 37 is coupled onto the said hollow rod; the said chain 37 is inserted through the non-solid portion of the hollow rod and thereby connected to the rear of the handle section 30, with a key 4 sleeved onto the said chain 37 by inserting the chain 37 through the hole of the said key 4 to link it onto the chain 37.

In yet another embodiment of the invention herein, the knife brand trademark can be imprinted onto the said protective circular cap 341 to enhance the appearance of the said folding knife 3.

1. A single blade foldable knife comprised of:
a foldable knife having a handle section disposed at one extremity and a blade situated at its other extremity, wherein the said handle section is of a planar shape and has a suitably situated resilient member; the said blade is pivotably conjoined to an appropriate position at one extremity of the said handle section such that when the said blade is unfolded, the end of the said resilient member is postured against the bottom portion of the said blade and thereby further locks the said blade into position; and when the said resilient member is pressed, the bottom portion of the said blade is released from the end of the resilient member, enabling the said blade to be folded into the said handle section;
a protective component disposed on the said handle section at a position facing the cutting edge tip of the said blade when the said blade is folded and fixed onto the said handle section by a hollow rod, and a protective circular cap is mounted on the end of the said hollow rod such that a gap is formed between the said circular cap and the said handle section that contains the said tip of the said cutting edge;
as such, when the said blade is folded, the said tip of the said blade cutting edge is nested in the said protective component.

2. A single blade foldable knife as claimed in claim 1 in which the said hollow rod has a chain is coupled onto it.

3. A single blade foldable knife as claimed in claim 2 in which the said chain has a key sleeved onto it.

4. A single blade foldable knife as claimed in claim 1 in which the said protective circular cap can be imprinted with a knife brand trademark.
